(19) United States
(12) Patent Application Publication
(10) Pub. No.: US 2019/0324394 A1
(43) Pub. Date: Oct. 24, 2019

(54) IMAGE FORMING APPARATUS, RECORDING MEDIUM, AND CONTROL METHOD

(71) Applicant: SHARP KABUSHIKI KAISHA, Sakai City (JP)

(72) Inventor: YOSHINORI SHIRAISHI, Sakai City (JP)

(21) Appl. No.: 16/389,474

(22) Filed: Apr. 19, 2019

(30) Foreign Application Priority Data
Apr. 24, 2018 (JP) 2018-082721

(51) Int. Cl. G03G 15/00

(52) U.S. Cl. CPC G03G 15/6576

(57) ABSTRACT

An image forming apparatus includes a delivering unit that delivers a sheet to an attached device. The delivering unit includes a sheet discharge roller and a pair of delivering guides. When the sheet is curled, the delivering guides change mutual relative positions so that a supplementary conveyance path inclined in a direction opposite to a curl direction of the sheet is formed on a downstream side of the sheet discharge roller in a sheet conveyance direction.

### BACKGROUND

### 1. Field

The present disclosure relates to an image forming apparatus, a recording medium, and a control method, and particularly relates to an image forming apparatus including a delivering unit that delivers, to an attached device, for example, such as a post-processing device, a sheet on which an image has been formed, a recording medium, and a control method.

### 2. Description of the Related Art

A conventional example of such a kind of image forming apparatus is disclosed in Japanese Unexamined Patent Application Publication No. 2010-163248. A technique of Japanese Unexamined Patent Application Publication No. 2010-163248 relates to a relay conveyance device that is provided in an image forming apparatus and guides a sheet, on which an image has been formed, to a post-processing device (attached device). The relay conveyance device includes a second guide plate provided in a sheet discharge slit and the second guide plate is formed by bending a part of a side wall on the post-processing device side. A protruding end on a downstream side of the second guide plate extends in an outward direction of a housing from a wall surface of the side wall and a protruding end on an upstream side thereof extends in an inward direction of the housing over an allowance space formed between a guide member and an inner surface of a second side wall, so that a sheet is smoothly guided to a sheet feed port of the post-processing device.

A sheet delivered from the image forming apparatus to the attached device such as the post-processing device may be curled, for example, when the sheet is heated and pressurized by a fixing unit. However, the technique of Japanese Unexamined Patent Application Publication No. 2010-163248 takes no consideration in dealing with a case where the sheet is curled, so that a malfunction such as sheet jamming may be caused when the curled sheet is delivered to the attached device.

Thus, the disclosure mainly provides a novel image forming apparatus, a novel recording medium, and a novel control method.

The disclosure also provides an image forming apparatus, a recording medium, and a control method that are able to appropriately deliver a sheet to an attached device even when curl is generated in the sheet.

### SUMMARY

An aspect of the disclosure is an image forming apparatus including a delivering unit that delivers a sheet, on which an image has been formed, to an attached device, and the image forming apparatus includes: a curl detection unit that detects curl information of the sheet, which includes existence of curl; a sheet discharge roller that is provided in the delivering unit; a pair of delivering guides that is provided in the delivering unit so as to be able to change mutual relative positions; and a guide control unit that, when generation of curl in the sheet is detected by the curl detection unit, changes the relative positions of the pair of delivering guides so that a supplementary conveyance path inclined in a direction opposite to a curl direction of the sheet is formed on a downstream side of the sheet discharge roller in a sheet conveyance direction.

An aspect of the disclosure is a non-transitory recording medium in which a control program of an image forming apparatus that includes a delivering unit that delivers a sheet, on which an image has been formed, to an attached device, a sheet discharge roller that is provided in the delivering unit, and a pair of delivering guides that is provided in the delivering unit so as to be able to change mutual relative positions is stored, in which a program that causes a processor of the image forming apparatus to execute performing curl detection processing of detecting curl information of the sheet, which includes existence of curl, and performing guide control processing of changing, when generation of curl in the sheet is detected by the curl detection unit, the relative positions of the pair of delivering guides so that a supplementary conveyance path inclined in a direction opposite to a curl direction of the sheet is formed on a downstream side of the sheet discharge roller in a sheet conveyance direction is stored.

An aspect of the disclosure is a control method of an image forming apparatus that includes a delivering unit that delivers a sheet, on which an image has been formed, to an attached device, a sheet discharge roller that is provided in the delivering unit, and a pair of delivering guides that is provided in the delivering unit so as to be able to change mutual relative positions, and the method includes: detecting curl information of the sheet, which includes existence of curl; and changing, when generation of curl in the sheet is detected, the relative positions of the pair of delivering guides so that a supplementary conveyance path inclined in a direction opposite to a curl direction of the sheet is formed on a downstream side of the sheet discharge roller in a sheet conveyance direction.

Features and advantages of the disclosure will be further apparent from detailed description of examples, which is given below with reference to drawings.

### BRIEF DESCRIPTION OF THE DRAWINGS

FIG. 1 is an explanatory diagram illustrating an image forming system in which a post-processing device is connected to an image forming apparatus that is a first example of the disclosure;

FIG. 2 is an explanatory diagram schematically illustrating an inner structure of the image forming apparatus of FIG. 1;

FIG. 3 is an explanatory diagram schematically illustrating an inner structure of the post processing device of FIG. 1;

FIG. 4 is an explanatory diagram illustrating a relay conveyance device included in the image forming apparatus of FIG. 1;

FIGS. 5A to 5C are explanatory diagrams illustrating movement of a curl detection sensor included in the relay conveyance device of FIG. 4 when downward curl is detected;

FIGS. 6A to 6C are explanatory diagrams illustrating movement of a curl detection sensor included in the relay conveyance device of FIG. 4 when upward curl is detected;

FIG. 7 is a front view illustrating delivering guides included in the relay conveyance device of FIG. 4;

FIG. 8 is a side view illustrating the delivering guides of FIG. 7;

FIG. 9 is a block diagram illustrating an example of an electric configuration of the image forming apparatus of FIG. 1;

FIGS. 10A to 10C are explanatory diagrams illustrating an operation of the delivering guides when a sheet is downwardly curled;

FIG. 11 is an explanatory diagram schematically illustrating a state where the sheet that is downwardly curled is guided by the delivering guides;

FIGS. 12A to 12C are explanatory diagrams illustrating an operation of the delivering guides when the sheet is upwardly curled;

FIG. 13 is an explanatory diagram schematically illustrating a state where the sheet that is upwardly curled is guided by the delivering guides;

FIG. 14 is an explanatory diagram illustrating an example of a memory map of a RAM illustrated in FIG. 9;

FIG. 15 is a flowchart illustrating an example of downward curl detection processing of the image forming apparatus of FIG. 1;

FIG. 16 is a flowchart illustrating an example of entire processing of guide control in the image forming apparatus of FIG. 1;

FIG. 17 is a flowchart illustrating an example of curl determination processing of the image forming apparatus of FIG. 1;

FIG. 18 is a flowchart illustrating an example of processing of moving the delivering guides of the image forming apparatus of FIG. 1;

FIGS. 19A and 19B are explanatory diagrams schematically illustrating a state where a sheet is guided by delivering guides included in an image forming apparatus of a second example of the disclosure; and

FIG. 20 is a flowchart illustrating an example of entire processing of guide control in an image forming apparatus of a third example of the disclosure.

### DESCRIPTION OF THE EMBODIMENTS

### First Example

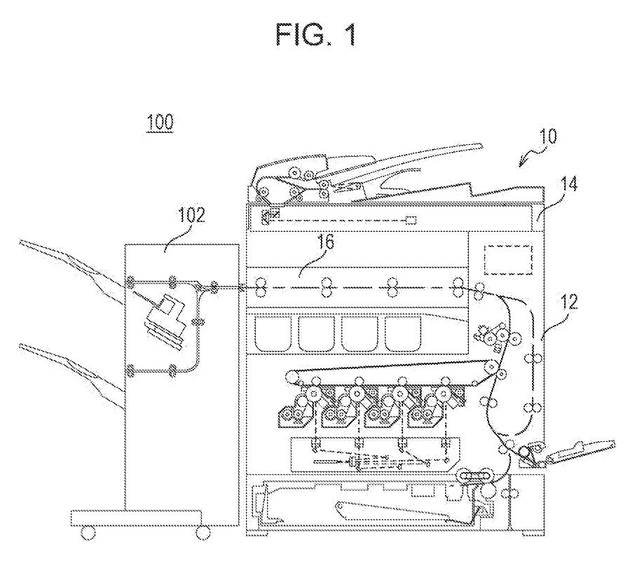

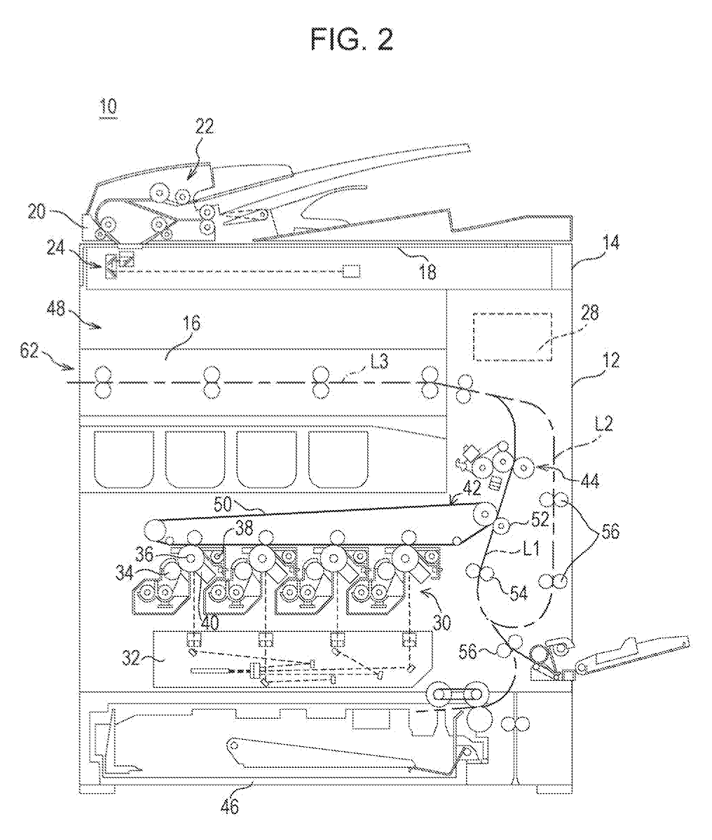

As illustrated in FIGS. 1 and 2, an image forming apparatus 10 that is an example of the disclosure is a color multifunction peripheral having a copy function, a printer function, a scanner function, a facsimile function, and the like, and electrophotographically forms a multicolor or monochromatic image on a sheet (recording medium). The image forming apparatus 10 of the example is attached with a post-processing device 102 that applies post processing to a sheet on which an image has been formed and thus constitutes an image forming system 100.

However, the image forming apparatus 10 may be any of a copier, a facsimile machine, a printer, and the like, or may be a multifunction peripheral in which at least two of them are combined or a monochromatic image forming apparatus.

First, a configuration of the image forming apparatus 10 will be schematically described. As illustrated in FIG. 2, the image forming apparatus 10 includes an apparatus main body 12 provided with an image forming unit 30, an image reading device 14 arranged above the apparatus main body 12, and a relay conveyance device 16 arranged in an in-body sheet discharge unit 48 of the apparatus main body 12.

The image reading device 14 includes a document platen 18 formed of a transparent material. Above the document platen 18, a document pressing cover 20 is attached via a hinge or the like so as to be freely opened and closed. A document feed tray is provided on a top surface of the document pressing cover 20 and an ADF (automatic document feeder) 22 is provided inside thereof. The ADF 22 automatically feeds a document, which is placed on the document feed tray, one by one to an image reading position and discharges the document to a document discharge tray.

An image reading unit 24 built in the image reading device 14 includes a light source, a plurality of mirrors, an image forming lens, a line sensor, and the like. The image reading unit 24 exposes a surface of a document with use of the light source and guides reflected light, which is reflected from the surface of the document, to the image forming lens by the plurality of mirrors. Then, an image of the reflected light is formed on a light receiving element of the line sensor by the image forming lens. In the line sensor, luminance and chromaticity of the reflected light whose image is formed on the light receiving element are detected and image data based on an image of the surface of the document is generated. As the line sensor, a CCD (Charge Coupled Device), a CIS (Contact Image Sensor), or the like is used.

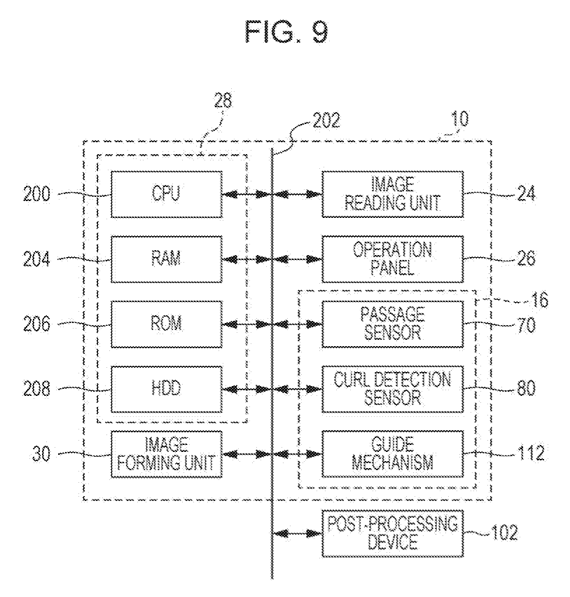

An operation panel 26 (refer to FIG. 9) that receives an input operation such as a print instruction by a user is provided on a front side of the image reading device 14. The operation panel 26 includes a display with a touch panel, a plurality of operation buttons, and the like.

A control unit 28 including a CPU 200 and the like, and the image forming unit 30 are provided in the apparatus main body 12. The control unit 28 transmits a control signal to each unit of the image forming apparatus 10 in accordance with an input operation or the like to the operation panel 26 and causes the image forming apparatus 10 to execute various operations.

The image forming unit 30 includes an exposure unit 32, a development unit 34, a photosensitive drum 36, a cleaner unit 38, a charger 40, a transfer device 42, a fixing unit 44, and the like, and forms an image on a sheet that is fed from a sheet feed cassette 46 or the like. The sheet on which the image has been formed is guided to the post-processing device 102 via the relay conveyance device 16 installed in the in-body sheet discharge unit 48. As image data for forming an image on a sheet, image data that is read by the image reading unit 24, image data that is transmitted from an external computer, or the like is used.

Note that, image data handled in the image forming apparatus 10 corresponds to a color image using four colors of black (K), cyan (C), magenta (M), and yellow (Y). Thus, in order to form four kinds of latent images according to the respective colors, four development units 34, four photosensitive drums 36, four cleaner unit 38, and four chargers 40 are provided. Thus, four image stations are constituted.

The photosensitive drum 36 is an image bearing member that a photosensitive layer is formed on a surface of a cylindrical substrate having conductivity, and the charger 40 is a member for charging the surface of the photosensitive drum 36 at a predetermined electric potential. Further, the exposure unit 32 is constituted as a laser scanning unit (LSU) that includes a laser emitting unit, a reflection mirror, and the like, and exposes the surface of the photosensitive drum 36 that is charged, thereby forming an electrostatic latent image according to the image data on the surface of the photosensitive drum 36. The development unit 34 visualizes the electrostatic latent image, which is formed on the surface of the photosensitive drum 36, with toner of four colors (YMCK). Moreover, the cleaner unit 38 removes toner that remains on the surface of the photosensitive drum 36 after development and transfer of the image.

The transfer device 42 is a device that transfers the toner image formed on the photosensitive drum 36 onto a sheet, and includes an intermediate transfer unit 50 and a transfer roller 52. The intermediate transfer unit 50 includes an intermediate transfer belt, a suspension roller, four intermediate transfer rollers, and the like, and is arranged above the photosensitive drums 36. In image formation, a predetermined voltage is applied to the intermediate transfer rollers, and a transfer electric field is thereby formed between the photosensitive drums 36 and the intermediate transfer belt, and toner images formed on outer peripheral surfaces of the photosensitive drums 36 are sequentially transferred onto an outer peripheral surface of the intermediate transfer belt that circularly moves. Moreover, the transfer roller 52 is provided so as to press the intermediate transfer belt between the suspension roller and the transfer roller 52. In image formation, a predetermined voltage is applied to the transfer roller 52, and a transfer electric field is thereby formed between the intermediate transfer belt and the transfer roller 52, and the toner images formed on the outer peripheral surface of the intermediate transfer belt are transferred onto a sheet while the sheet passes through a transfer nip part between the intermediate transfer belt and the transfer roller 52.

The fixing unit 44 includes a heat roller and a pressure roller and is arranged above the transfer roller 52. The heat roller is set to have a predetermined fixing temperature, and when the sheet passes through a fixing nip part between the heat roller and the pressure roller, the toner images transferred onto the sheet are melted, mixed, and brought into pressure contact, and the toner images are thermally fixed to the sheet.

In such an apparatus main body 12, a first sheet conveyance path L1 in which a sheet fed from the sheet feed cassette 46 or the like is conveyed to the relay conveyance device 16 via a resist roller 54, the transfer nip part, and the fixing nip part is formed. Moreover, a second sheet conveyance path L2 through which, when double-side printing is performed on a sheet, the sheet on which single-side printing has been finished and which has passed through the fixing nip part is returned to the first sheet conveyance path L1 on an upstream side of the transfer roller 52 in a sheet conveyance direction is formed. In the first sheet conveyance path L1 and the second sheet conveyance path L2, a plurality of conveyance rollers 56 that supplementarily apply a propelling force to a sheet are appropriately provided.

The relay conveyance device 16 is provided so as to be attachable to and detachable from the in-body sheet discharge unit 48 of the apparatus main body 12. The relay conveyance device 16 is a device that relays and conveys, to the post-processing device 102, a sheet fed from a sheet discharge port of the apparatus main body 12 and having an image formed thereon, and includes a delivering unit 62 that delivers the sheet to the post-processing device 102. A specific configuration of the relay conveyance device 16 will be described later.

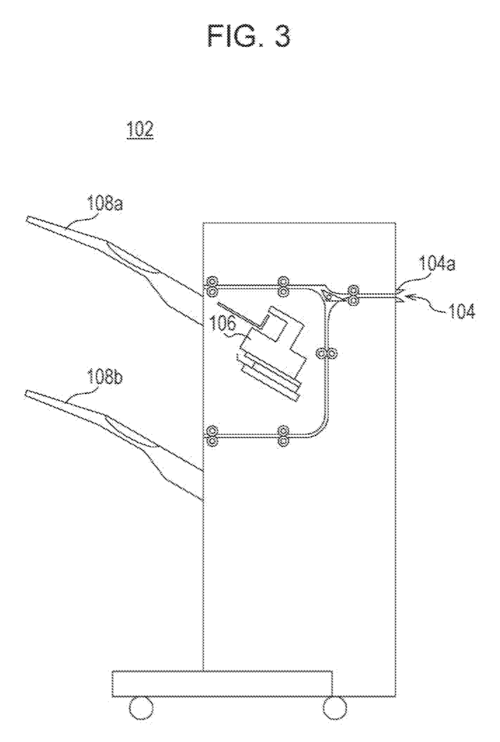

As illustrated in FIGS. 1 and 3, the post-processing device 102 is an example of an attached device connected to the image forming apparatus 10 and performs predetermined post-processing for a sheet on which an image has been formed in the apparatus main body 12. The post-processing device 102 includes a sheet feed port 104 through which the sheet is received from the delivering unit 62 of the relay conveyance device 16, and the sheet feed port 104 is provided with a reception guide 104a. A post-processing unit 106 is provided in a housing of the post-processing device 102. The sheet conveyed into the housing of the post-processing device 102 through the sheet feed port 104 is subjected to post-processing, such as staple processing, punch processing, or sort processing, by the post-processing unit 106, and then discharged to a first sheet discharge tray 108a. However, a sheet for which post-processing is not necessary is discharged to a second sheet discharge tray 108b without passing through the post-processing unit 106.

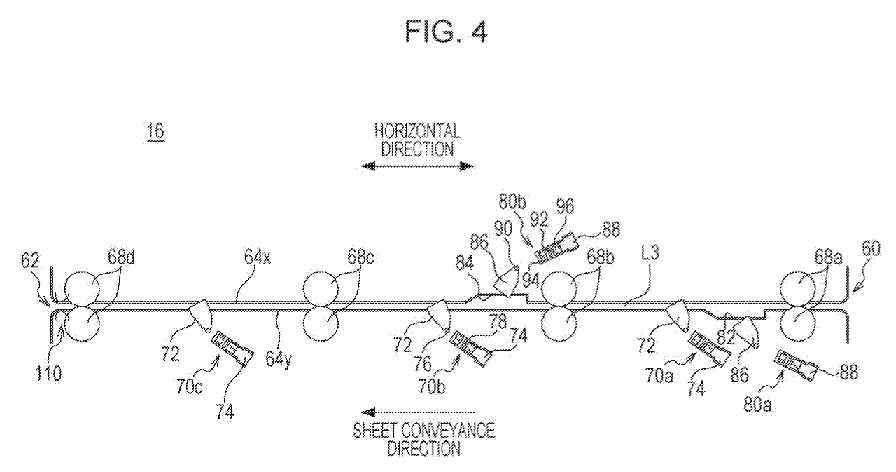

Next, the relay conveyance device 16 including the delivering unit 62 will be specifically described. As illustrated in FIG. 4 with FIG. 2, the relay conveyance device 16 is generally formed in a substantially rectangular parallelepiped shape, and a third sheet conveyance path (relay conveyance path) L3 that extends almost horizontally from a right side to a left side is formed in the housing of the relay conveyance device 16. At an upstream end of the third sheet conveyance path L3 in the sheet conveyance direction, a receiving unit 60 that receives a sheet through the sheet discharge port of the apparatus main body 12 is provided, and at a downstream end thereof, the delivering unit 62 that delivers a sheet to the sheet feed port 104 of the post-processing device 102 is provided.

The third sheet conveyance path L3 is constituted by a pair of paper guides 64, i.e., an upper paper guide 64x and a lower paper guide 64y that guides a sheet so as to hold front and rear sides of the sheet. A plurality of conveyance rollers 68 are provided in the third sheet conveyance path L3. In the present example, four conveyance rollers 68 including a first conveyance roller 68a, a second conveyance roller 68b, a third conveyance roller 68c, and a fourth conveyance roller 68d are provided in the third sheet conveyance path L3. Among them, the first conveyance roller 68a is a sheet feed roller provided in the receiving unit 60 and the fourth conveyance roller 68d is a sheet discharge roller provided in the delivering unit 62.

In the third sheet conveyance path L3, a plurality of passage sensors 70 that detect passage of a sheet are provided. In the present example, three passage sensors 70 including a first passage sensor 70a, a second passage sensor 70b, and a third passage sensor 70c are provided in the third sheet conveyance path L3. The first passage sensor 70a is a passage sensor that is used to detect downward curl of the sheet and is provided at a position between the first conveyance roller 68a and the second conveyance roller 68b. The second passage sensor 70b is a passage sensor that is used to detect upward curl of the sheet and is provided at a position between the second conveyance roller 68b and the third conveyance roller 68c. The third passage sensor 70c is a passage sensor that counts an operation timing of a delivering guide 110 described below and is provided at a position between the third conveyance roller 68c and the fourth conveyance roller 68d.

Note that, for convenience of description, in a case where it is not necessary to distinguish the first passage sensor 70a, the second passage sensor 70b, and the third passage sensor 70c, the first passage sensor 70a, the second passage sensor 70b, and the third passage sensor 70c are collectively called passage sensors 70. Similarly, names of other components are also collectively called in some cases.

Though a known sensor is able to be adopted as appropriate for each of the passage sensors 70, a sensor of a contact type is used in the present example. To describe briefly, the passage sensor 70 includes an actuator member 72 and an optical sensor 74 of a transmissive type. The actuator member 72 is rotatable around a rotational axis 76 as a fulcrum and has a tip end provided so as to protrude into the third sheet conveyance path L3. A shielding member 78 is provided on a basal end side of the actuator member 72. The optical sensor 74 includes a light emitting unit and a light receiving unit that are arranged with a predetermined interval and the shielding member 78 is arranged between the light emitting unit and the light receiving unit. The optical sensor 74 is turned on when light output from the light emitting unit is received by the light receiving unit, and is turned off when the light output from the light emitting unit is not received by the light receiving unit.

In such a passage sensor 70, when there is no sheet at a position where the tip end of the actuator member 72 is provided, the light from the light emitting unit is in a state of being shielded by the shielding member 78 and is not received by the light receiving unit. That is, the optical sensor 74 is turned off. On the other hand, when a sheet is conveyed to the position where the tip end of the actuator member 72 is provided, the actuator member 72 has the tip end pressed by the sheet and thus rotates forward in the sheet conveyance direction, and the shielding member 78 also rotates accordingly. When the shielding member 78 is deviated from the position between the light emitting unit and the light receiving unit, the light output from the light emitting unit is received by the light receiving unit. Thereby, the optical sensor 74 is turned on. After that, when the sheet passes through the position where the tip end of the actuator member 72 is provided, the actuator member 72 is returned to an original position due to an action of a torsion spring or the like and the optical sensor 74 is turned off. That is, each of the passage sensors 70 is in an on state when a leading end of the sheet reaches, and is kept in the on state during passage of the sheet, and is returned to an off state when a rear end of the sheet has passed.

A curl detection sensor 80 that detects curl information of a sheet is further provided in the third sheet conveyance path L3. Though a known sensor is able to be adopted as appropriate for the curl detection sensor 80, a sensor of a contact type that has a similar configuration to that of the passage sensor 70 is used to detect whether or not the sheet is curled (existence of curl) and a direction thereof (direction of curl) in the present example. Specific description will be given below.

In the lower paper guide 64y, a downward recess 82 that is recessed downwardly is formed on the upstream side of the first passage sensor 70a in the sheet conveyance direction. Further, in the upper paper guide 64x, an upward recess 84 that is recessed upwardly is formed on the upstream side of the second passage sensor 70b in the sheet conveyance direction. Two curl detection sensors 80 including a downward curl detection sensor 80a and an upward curl detection sensor 80b are provided in the third sheet conveyance path L3. The downward curl detection sensor 80a is a sensor that detects downward curl in which an end of a sheet is downwardly curled and is provided at a position corresponding to the downward recess 82. On the other hand, the upward curl detection sensor 80b is a sensor that detects upward curl in which an end of a sheet is curled upwardly and is provided at a position corresponding to the upward recess 84.

Each of the curl detection sensors 80 includes an actuator member 86 and an optical sensor 88 of a transmissive type. The actuator member 86 is rotatable around a rotational axis 90 as a fulcrum and has a tip end provided so as to protrude into the downward recess 82 or into the upward recess 84. A shielding member 92 is provided on a basal end side of the actuator member 86. On the other hand, the optical sensor 88 includes a light emitting unit 94 and a light receiving unit 96 that are arranged with a predetermined interval and the shielding member 92 is arranged between the light emitting unit 94 and the light receiving unit 96. The optical sensor 88 is turned on when light output from the light emitting unit 94 is received by the light receiving unit 96, and is turned off when the light output from the light emitting unit 94 is not received by the light receiving unit 96.

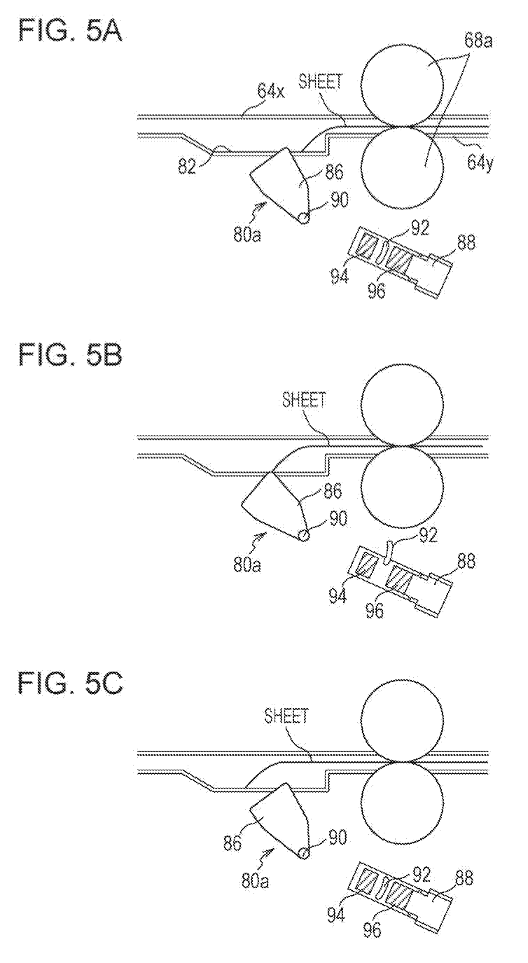

FIGS. 5A to 5C are explanatory diagrams for explaining movement of the downward curl detection sensor 80a when a sheet that is downwardly curled is conveyed. As illustrated in FIG. 5A, before a front end of the sheet that is downwardly curled reaches the position of the tip end of the actuator member 86, the actuator 86 is in a standard state where the actuator 86 rises, and the light from the light emitting unit 94 is shielded by the shielding member 92 and is not received by the light receiving unit 96. That is, the optical sensor 88 is turned off. Next, as illustrated in FIG. 5B, when the front end of the sheet that is downwardly curled reaches the position of the tip end of the actuator member 86, the tip end of the actuator member 86 is pressed by the front end of the sheet and thus rotates forward in the sheet conveyance direction, and the shielding member 92 also rotates accordingly. When the shielding member 92 is deviated from the position between the light emitting unit 94 and the light receiving unit 96, the light output from the light emitting unit 94 is received by the light receiving unit 96. Thereby, the optical sensor 88 is turned on, and on the basis of detection information thereof, downward curl of the sheet is detected. After that, when the front end of the sheet has passed through the position of the tip end of the actuator member 86 as illustrated in FIG. 5C, the actuator member 86 is returned to the original standard position due to an action of a torsion spring or the like and the optical sensor 88 is turned off. Note that, in a case where a sheet that is not curled or a sheet that is upwardly curled is conveyed, the sheet passes above the actuator member 86 without pressing the actuator member 86, so that the downward curl detection sensor 80a does not react.

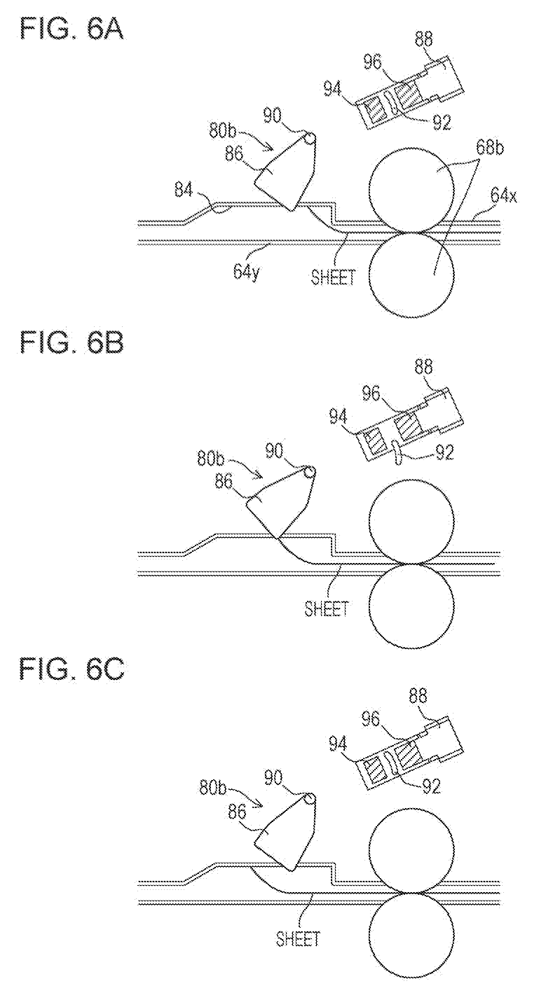

FIGS. 6A to 6C are explanatory diagrams for explaining movement of the upward curl detection sensor 80b when a sheet that is upwardly curled is conveyed. Since the movement is similar to the movement of the downward curl detection sensor 80a when downward curl is detected, description will be given briefly. As illustrated in FIG. 6A, before a front end of the sheet that is upwardly curled reaches, the actuator member 86 is in the standard state where the actuator member 86 rises, and the optical sensor 88 is turned off. Next, as illustrated in FIG. 6B, when the front end of the sheet that is upwardly curled reaches the position of the tip end of the actuator member 86, the tip end of the actuator member 86 is pressed by the front end of the sheet and thus rotates forward in the sheet conveyance direction, and the shielding member 92 is deviated from the position between the light emitting unit 94 and the light receiving unit 96. Thereby, the optical sensor 88 is turned on, and on the basis of detection information thereof, upward curl of the sheet is detected. After that, as illustrated in FIG. 6C, when the front end of the sheet has passed, the actuator member 86 is returned to the original standard position and the optical sensor 88 is turned off. Note that, in a case where a sheet that is not curled or a sheet that is downwardly curled is conveyed, the sheet passes below the actuator member 86 without pressing the actuator member 86, so that the upward curl detection sensor 80b does not react.

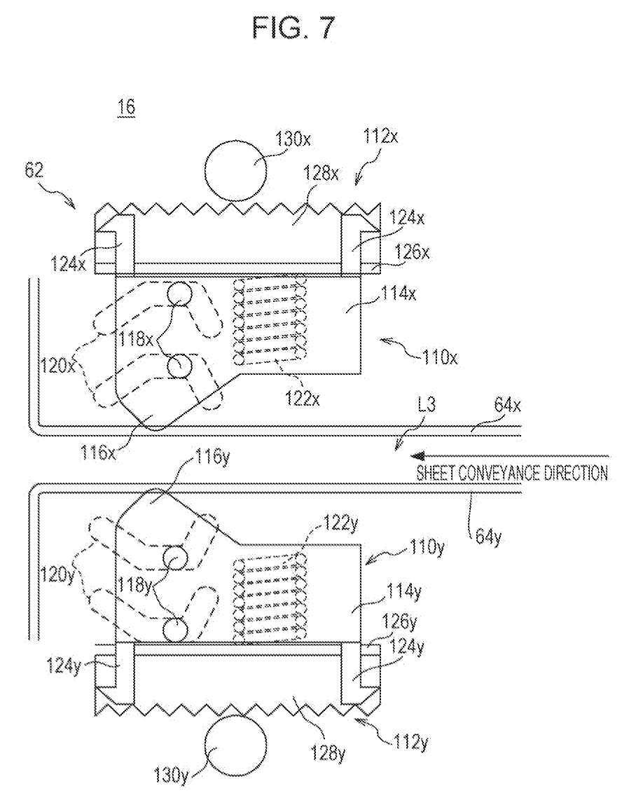

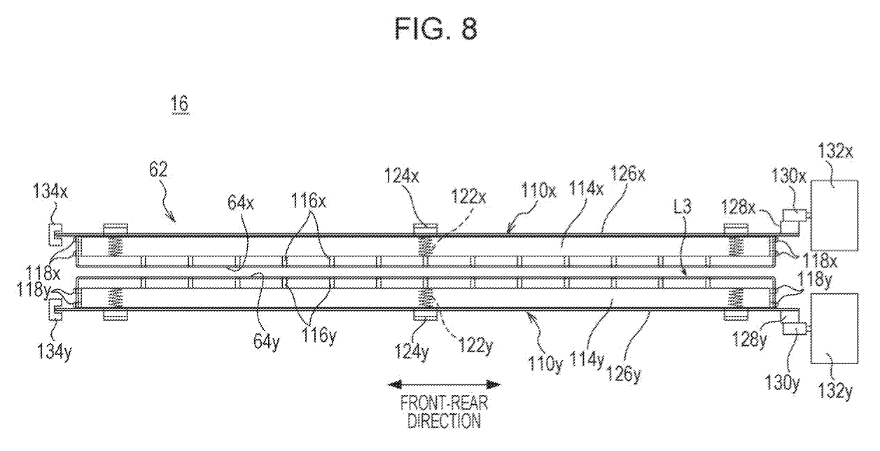

As illustrated in FIGS. 7 and 8 with FIG. 4, the delivering unit 62 of the relay conveyance device 16 is provided with a pair of delivering guides 110 including an upper guide 110x and a lower guide 110y. The paired delivering guides 110 (i.e. the upper guide 110x and the lower guide 110y) are conveyance guides that support delivering of a sheet to the post-processing device 102 and are provided so as to be able to change mutual relative positions. In the present example, a rack and pinion method is used as a movement mechanism of the delivering guides 110.

Note that, an upper guide mechanism 112x that includes the upper guide 110x and the movement mechanism thereof and a lower guide mechanism 112y that includes the lower guide 110y and the movement mechanism thereof have similar configurations other than that a vertical positional relationship is reversed. Therefore, names of the components are called collectively with indexes of “x” and “y” omitted except for a case where the components are to be distinguished, and redundant description thereof will be omitted.

Each of the delivering guides 110 includes a base 114 having a hollow rectangular parallelepiped shape that is long in a front-rear direction (direction orthogonal to the sheet conveyance direction) and a plurality of guide pieces 116 provided on a surface of the base 114 on the third sheet conveyance path L3 side. The respective guide pieces 116 are formed into a chevron-like rib shape and are arranged so as to extend in the sheet conveyance direction and so as to be arrayed at predetermined intervals in the direction orthogonal to the sheet conveyance direction.

On each of end surfaces (a front surface and a rear surface) of the base 114, two guide pins 118 that are vertically aligned are formed. On the other hand, each of the paper guides 64 has side plates (a front plate and a rear plate) on each of which two guide holes 120 that are vertically aligned are formed. Each of the guide holes 120 extends in a horizontal direction (sheet conveyance direction) so as to be bent in a substantially trapezoid shape. When the guide pins 118 are inserted into the guide holes 120, the delivering guide 110 is supported so as to be movable in the horizontal direction and a vertical direction with respect to the side plates of the paper guide 64. A plurality of compression springs 122 are incorporated in the base 114 and the delivering guide 110 is urged toward the third sheet conveyance path L3 side.

On a surface of the base 114, which is opposite to the third sheet conveyance path L3 side, a plurality of claws 124 are provided, and a connecting plate 126 of a long plate shape is connected to the claws 124. To one end of the connecting plate 126, a rack gear 128 that extends in the horizontal direction is fixed. A pinion gear 130 is connected to the rack gear 128 and a motor 132 is connected to the pinion gear 130. When the motor 132 is driven to rotate the pinion gear 130, the rack gear 128 moves in the horizontal direction. With the movement of the rack gear 128, the delivering guide 110 moves along the guide holes 120 via the connecting plate 126 and the claws 124. At a position corresponding to the other end of the connecting plate 126, an optical sensor 134 that detects a position of the rack gear 128 (consequently, a position of the delivering guide 110) is provided.

In the present example, the delivering guide 110 is able to be displaced to three positions of a retracted position, a downstream-side regulating position, and an upstream-side regulating position. Here, the retracted position is an initial position (standard position) where a guide piece 116 does not protrude into the third sheet conveyance path L3. The downstream-side regulating position is a position where the guide piece 116 protrudes into the third sheet conveyance path L3 at a position on the downstream side of the retracted position in the sheet conveyance direction. Further, the upstream-side regulating position is a position where the guide piece 116 protrudes into the third sheet conveyance path L3 at a position on the upstream side of the retracted position in the sheet conveyance direction. Here, at the downstream-side regulating position and the upstream-side regulating position, a tip end of the guide piece 116 protrudes to a position over a center of the third sheet conveyance path L3 in the vertical direction.

FIG. 9 is a block diagram illustrating an example of an electric configuration of the image forming apparatus 10. As illustrated in FIG. 9, the image forming apparatus 10 includes the CPU 200 and the CPU 200 is connected to a RAM 204, a ROM 206, an HDD 208, and the like via a bus 202. The CPU 200, the RAM 204, the ROM 206, and the HDD 208 constitute the control unit 28 described above. Moreover, the image reading unit 24, the operation panel 26, the image forming unit 30, and the passage sensors 70, the curl detection sensors 80, and guide mechanisms 112 of the relay conveyance device 16, etc., which are described above, are connected to the CPU 200 (control unit 28) via the bus 202. Further, the post-processing device 102 that is the attached device is connected to the CPU 200 via the bus 202.

The CPU 200 entirely controls the image forming apparatus 10 and the image forming system 100. The RAM 204 is used as a working area and a buffer area of the CPU 200. The ROM 206 stores default values related to a program of the image forming apparatus 10 and various kinds of information. The HDD 208 is a main storage device of the image forming apparatus 10 and saves image data (scanned image data) read by the image reading unit 204, image data transmitted from an external computer, or the like.

The passage sensors 70 include the first passage sensor 70a, the second passage sensor 70b, and the third passage sensor 70c. The CPU 200 detects passage (position) of a sheet on the basis of information about on/off of the optical sensor 74, which is input from the passage sensors 70. The curl detection sensors 80 include the lower curl detection sensor 80a and the upper curl detection sensor 80b. The CPU 200 detects sheet curl information including a existence of curl and a direction thereof on the basis of information about on/off of the optical sensor 88, which is input from the curl detection sensors 80. The guide mechanisms 112 include the upper guide mechanism 112x and the lower guide mechanism 112y. As described below, the CPU 200 controls the guide mechanisms 112 in accordance with the sheet curl information and causes the guide pieces 116 of the delivering guides 110 to appropriately form a supplementary conveyance path L4.

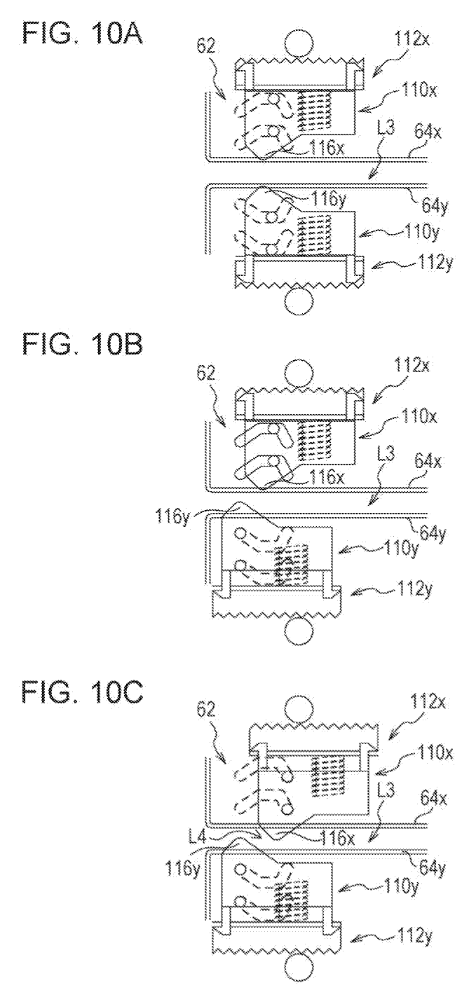

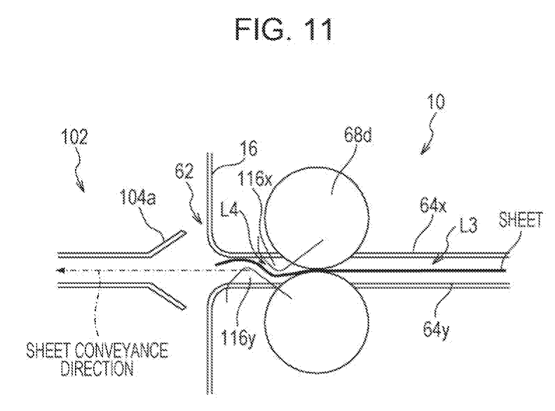

Next, an example of an operation of the delivering guides 110 when a sheet is curled in such an image forming apparatus 10 will be described with reference to FIGS. 10A to 10C, 11, 12A to 12C, and 13. FIGS. 10A to 10C and 11 are explanatory diagrams each illustrating an operation of the delivering guides 110 when the sheet is downwardly curled.

As illustrated in FIG. 10A, at a normal time such as a case where there is no sheet conveyed through the third sheet conveyance path L3 or a case where a sheet is not curled, the delivering guides 110 wait at the retracted position where the guide pieces 116 do not protrude into the third sheet conveyance path L3.

On the other hand, in a case where the sheet conveyed in the third sheet conveyance path L3 is downwardly curled, first, as illustrated in FIG. 10B, by driving a motor 132y of the lower guide mechanism 112y, the lower guide 110y is caused to move to the downstream-side regulating position and a guide piece 116y is caused to protrude into the third sheet conveyance path L3. A timing when the lower guide 110y is caused to move to the downstream-side regulating position is desired to be before a front end of the sheet reaches the guide piece 116y and is set in the present example as the same timing as passage of the front end of the sheet through the third passage sensor 70c.

After that, as illustrated in FIG. 10C, by driving a motor 132x of the upper guide mechanism 112x, the upper guide 110x is caused to move to the upstream-side regulating position and a guide piece 116x is caused to protrude into the third sheet conveyance path L3. A timing when the upper guide 110x is caused to move to the upstream-side regulating position is desired to be after the front end of the sheet passes through the guide piece 116x and is set in the present example as a timing immediately after passage of the front end of the sheet through the guide piece 116y of the lower guide 110y.

By the operation described above, the guide piece 116y of the lower guide 110y is positioned on the downstream side of the guide piece 116x of the upper guide 110x in the sheet conveyance direction and the tip ends of both the guide pieces 116 are positioned to be overlapped with each other in the vertical direction, and the supplementary conveyance path L4 that extends in an obliquely upward direction is formed on the downstream side of the fourth conveyance roller (sheet discharge roller) 68d in the sheet conveyance direction. That is, the supplementary conveyance path L4 that is inclined in a direction opposite to a curl direction of the sheet relative to the sheet conveyance direction is formed in the delivering unit 62.

As illustrated in FIG. 11, when the supplementary conveyance path L4 that extends in the obliquely upward direction is formed by the pair of delivering guides 110, the sheet that is downwardly curled is fed in the obliquely upward direction. Thereby, the front end of the sheet that is downwardly curled is inclined so as to be close to the sheet conveyance direction, so that the sheet is able to be delivered smoothly to the reception guide 104a of the post-processing device 102 from the image forming apparatus 10.

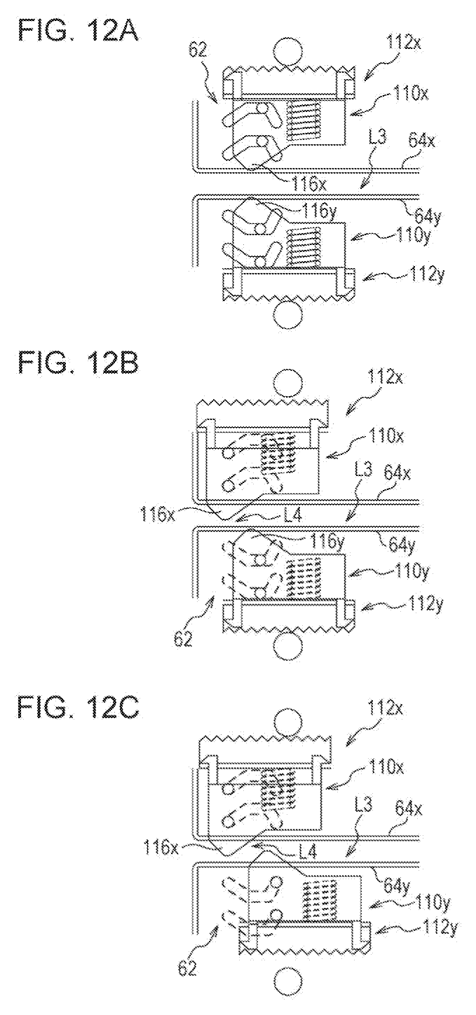

FIGS. 12A to 12C and 13 are explanatory diagrams each illustrating an operation of the delivering guides 110 when the sheet is upwardly curled. The operation of the delivering guides 110 at this times is similar to the operation when the sheet is downwardly curled, other than that the lower guide 110y and the upper guide 110x are operated in a reverse manner, so that description will be given briefly.

As illustrated in FIG. 12A, at a normal time, the delivering guides 110 wait at the retracted position where the guide pieces 116 do not protrude into the third sheet conveyance path L3. On the other hand, when the sheet conveyed in the third sheet conveyance path L3 is upwardly curled, first, as illustrated in FIG. 12B, at the same timing as passage of the front end of the sheet through the third passage sensor 70c, the upper guide 110x is caused to move to the downstream-side regulating position and the guide piece 116x is caused to protrude into the third sheet conveyance path L3. After that, as illustrated in FIG. 12C, at a timing immediately after the front end of the sheet passes through the guide piece 116x of the upper guide 110x, the lower guide 110y is caused to move to the upstream-side regulating position and the guide piece 116y is caused to protrude into the third sheet conveyance path L3. By the operation described above, the guide piece 116x of the upper guide 110x is positioned on the downstream side of the guide piece 116y of the lower guide 110y in the sheet conveyance direction and the tip ends of both the guide pieces 116 are positioned to be overlapped with each other in the vertical direction, and the supplementary conveyance path L4 that extends in an obliquely downward direction is formed on the downstream side of the fourth conveyance roller 68d in the sheet conveyance direction.

As illustrated in FIG. 13, when the supplementary conveyance path L4 that extends in the obliquely downward direction is formed by the pair of delivering guides 110, the sheet that is upwardly curled is fed in the obliquely downward direction. Thereby, the front end of the sheet that is upwardly curled is inclined so as to be close to the sheet conveyance direction, so that the sheet is able to be delivered smoothly to the reception guide 104a of the post-processing device 102 from the image forming apparatus 10.

Note that, the pair of delivering guides 110 do not need to be operated with a time lag and may be moved at the same time, for example, at a timing when the front end of the sheet passes through the third passage sensor 70c. In consideration of occurrence of sheet jamming due to formation of the supplementary conveyance path L4, however, it is desirable that, after one of the delivering guides 110, which is arranged on the downstream side in the sheet conveyance direction, is moved, the other delivering guide 110 arranged on the upstream side in the sheet conveyance direction is moved. That is, it is desirable that, at the same time with one of the delivering guides 110 before the front end of the sheet reaches, the other delivering guide 110 arranged on the upstream side in the sheet conveyance direction is not moved but is moved after the front end of the sheet passes through the guide piece 116 of the other delivering guide 110.

The aforementioned operation of the image forming apparatus 10 is realized by the CPU 200 executing a control program read out and stored in the RAM 204. Specific processing will be described later with reference to a flowchart.

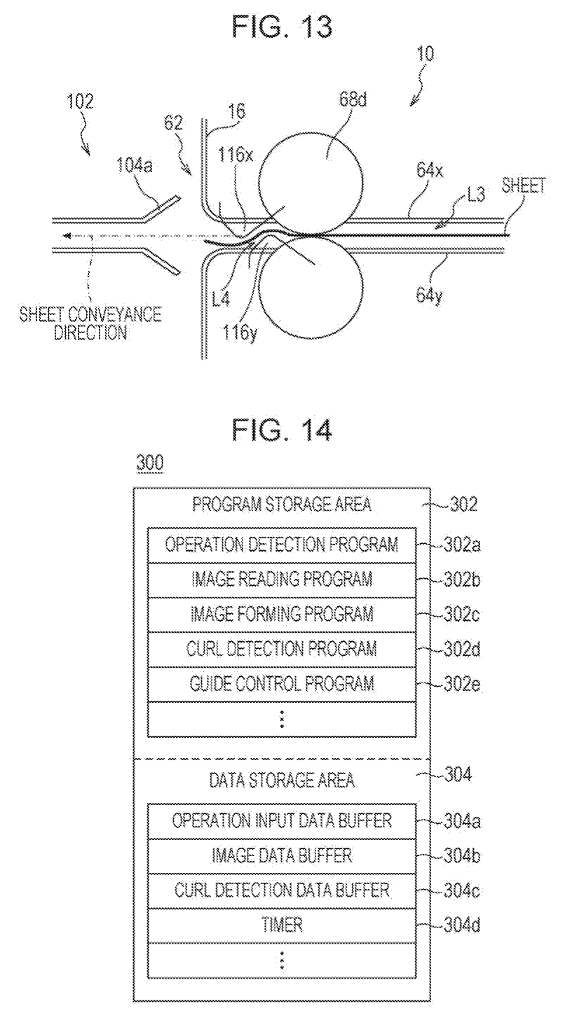

FIG. 14 is an explanatory diagram illustrating an example of a memory map 300 of the RAM 204 illustrated in FIG. 9. As illustrated in FIG. 14, the RAM 204 includes a program storage area 302 and a date storage area 304. In the program storage area 302, a control program for controlling the image forming apparatus 10 is stored. The control program includes an operation detection program 302a, an image reading program 302b, an image forming program 302c, a curl detection program 302d, a guide control program 302e, and the like.

The operation detection program 302a is a program by which an operation input from the operation panel 26 operated by a user is detected. For example, the operation input is operation data that is input upon operating various operation buttons such as a copy button and touch coordinate data that is input upon operating (touching) a touch panel.

The image reading program 302b is a program by which an operation of the image reading unit 24 is controlled and an image of an object placed on the document platen 18 or an object conveyed from the ADF 22 is read to generate image data (scanned image data).

The image forming program 302c is a program by which an operation of the image forming unit 30 is controlled and an image corresponding to image data is printed on a recording sheet (sheet) or the like.

The curl detection program 302d is a program by which sheet curl information (curled state) including existence of curl and a direction thereof is detected on the basis of states of the curl detection sensors 80 and the passage sensors 70.

The guide control program 302e is a program by which, when a sheet is curled, the guide mechanisms 112 are controlled at a predetermined timing and the supplementary conveyance path L4 is formed by the guide pieces 116 of the delivering guides 110.

The data storage area 304 includes an operation input data buffer 304a, an image data buffer 304b, a curl detection data buffer 304c, and a timer 304d.

The operation input data buffer 304a is a buffer in which an operation input from the operation panel 26 is temporarily stored. The image data buffer 304b is a buffer in which, for example, image data read by the image reading unit 24 and image data transmitted from an external computer are temporarily stored.

The curl detection data buffer 304c is a buffer in which a flag or the like used for detection and determination of curl is temporarily stored. The timer 304d is a timer for counting an operation timing of the delivering guide 110 and starts the count when the third passage sensor 70c is brought into an on state.

Note that, though not illustrated, another program for executing a function of the image forming apparatus 10 is also appropriately stored in the program storage area 302. Moreover, in the data storage area 304, another data used for execution of the control program is stored or another timer or flag used for execution of the control program is provided.

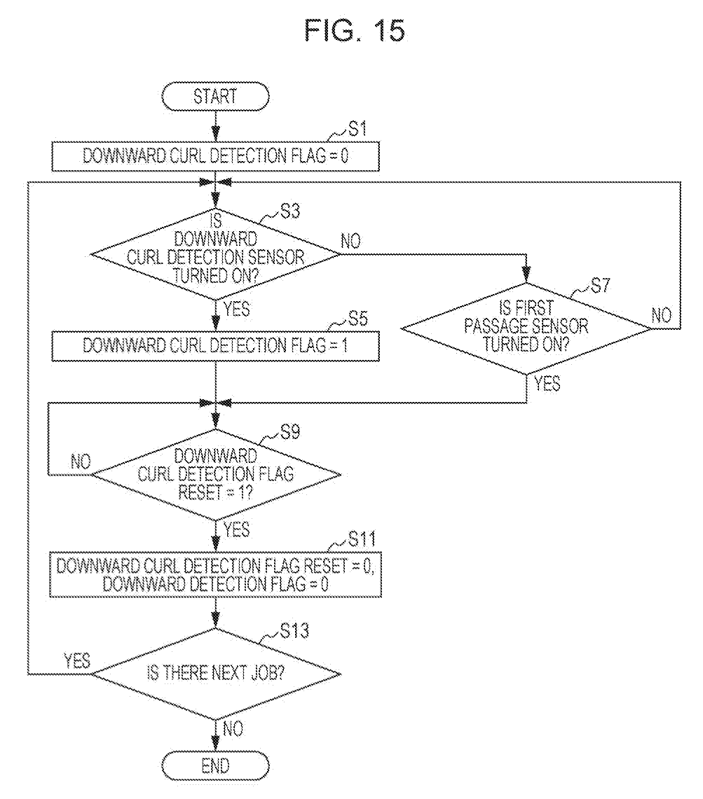

FIG. 15 is a flowchart illustrating an example of curl detection processing in the image forming apparatus 10. Here, an example of processing of detecting downward curl of a sheet on the basis of states of the downward curl detection sensor 80a and the first passage sensor 70a is indicated. Note that, upward curl of the sheet is detected on the basis of states of the upward curl detection sensor 80b and the second passage sensor 70b in a similar manner to the case of the downward curl, so that description thereof will be omitted.

As illustrated in FIG. 15, when a job starts, for example, upon pressing of a copy button by a user, first, a downward curl detection flag is set to 0 at step S1. That is, the CPU 200 resets the downward curl detection flag indicating that the sheet is downwardly curled.

At next step S3, whether or not the downward curl detection sensor 80a is turned on is determined. In a case of “YES” at step S3, that is, in a case where the downward curl detection sensor 80a changes to be in an on state, it is determined that the sheet is downwardly curled, and the procedure proceeds to step S5. The downward curl detection flag is set to 1 at step S5 and the procedure proceeds to step S9.

On the other hand, in a case of “NO” at step S3, that is, in a case where the downward curl detection sensor 80a remains in an off state, the procedure proceeds to step S7. At step S7, whether or not the first passage sensor 70a is turned on is determined. In a case of “NO” at step S7, that is, in a case where the first passage sensor 70a remains in the off state, the procedure returns to step S3. Alternatively, in a case of “YES” at step S7, that is, in a case where the first passage sensor 70a changes to be in the on state while the downward curl detection sensor 80a remains in the off state, it is determined that there is no curl and the procedure proceeds to step S9.

At step S9, whether or not a downward curl detection flag reset indicates 1 is determined. That is, the CPU 200 determines whether or not there is an instruction to reset the downward curl detection flag. In a case of “NO” at step S9, that is, in a case where there is no instruction to reset the downward curl detection flag, the downward curl detection flag is kept as it is until the instruction is given. On the other hand, in a case of “YES” at step S9, that is, in a case where there is an instruction to reset the downward curl detection flag, the procedure proceeds to step S11 and the downward curl detection flag reset and the downward curl detection flag are reset.

At next step S13, whether or not there is a next job is determined. In a case of “YES” at step S13, that is, in a case where there is a next job, the procedure returns to step S3. On the other hand, in a case of “NO” at step S13, that is, in a case where there is no next job, the curl detection processing ends.

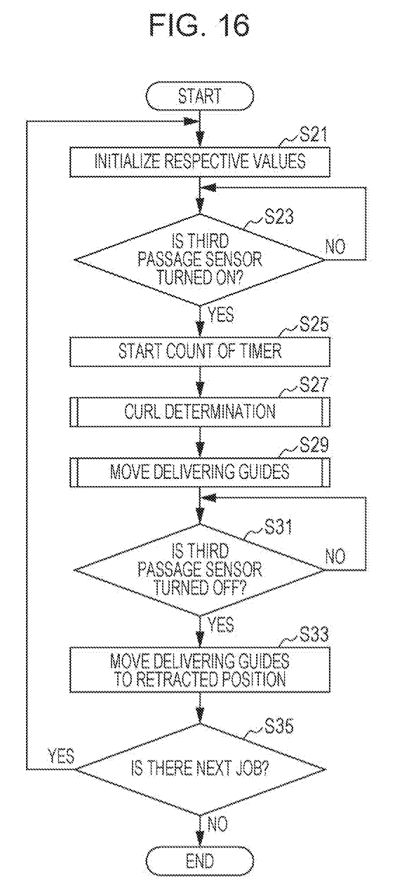

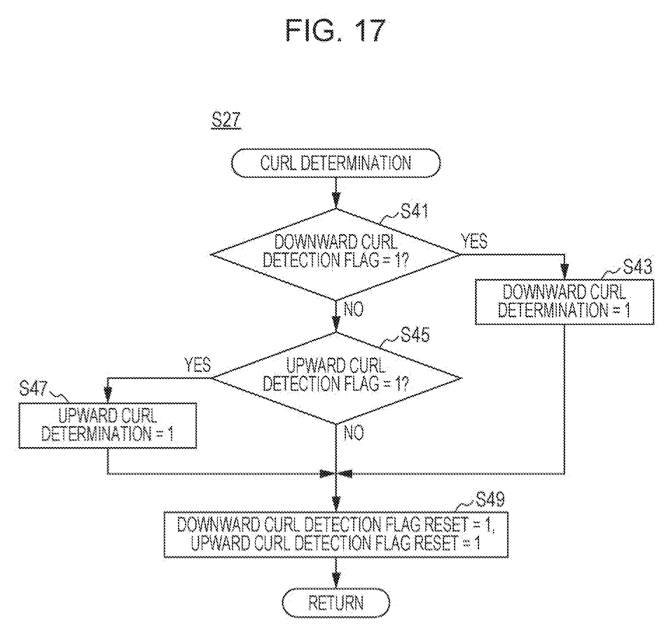

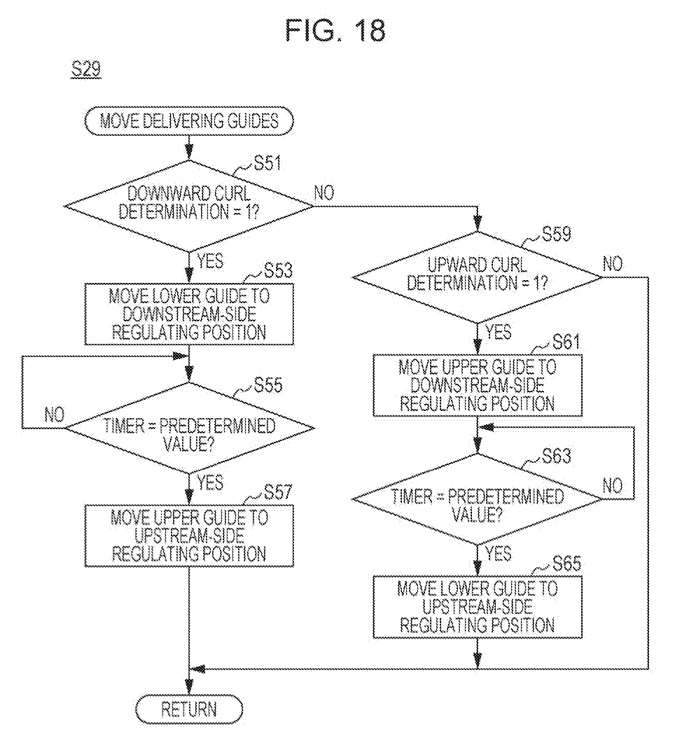

FIG. 16 illustrates an example of entire processing of guide control in the image forming apparatus 10. FIG. 17 is a flowchart illustrating an example of curl determination processing executed at step S27 of FIG. 16. FIG. 18 is a flowchart illustrating an example of processing of moving the delivering guides executed at step S29 of FIG. 16.

As illustrated in FIG. 16, when a job starts, for example, upon pressing of a copy button by a user, first, the CPU 200 initializes (resets) respective values of a flag, a timer, and the like at step S21. At next step S23, whether or not the third passage sensor 70c is turned on is determined. In a case of “NO” at step S23, that is, in a case where the third passage sensor 70c remains in the off state, the CPU 200 waits as it is until the third passage sensor 70c is turned on. On the other hand, in a case of “YES” at step 23, that is, in a case where the third passage sensor 70c changes to be in the on state, it is determined that a front end of the sheet reaches a detection position of the third passage sensor 70c, and the procedure proceeds to step S25. At step S25, the timer 304d starts to count.

At next step S27, the curl determination processing is performed. At step S27, as illustrated in FIG. 17, curl determination for determining existence of curl and a direction thereof is performed on the basis of the state of the curl detection flag. Here, first, whether or not the downward curl detection flag indicates 1 is determined at step S41. In a case of “YES” at step S41, that is, in a case where the downward curl detection flag indicates 1, downward curl determination is set to 1 at step S43 and the procedure proceeds to step S49. On the other hand, in a case of “NO” at step S41, that is, in a case where the downward curl detection flag indicates 0, the procedure proceeds to step S45.

At step S45, whether or not an upward curl detection flag indicates 1 is determined. In a case of “YES” at step S45, that is, in a case where the upward curl detection flag indicates 1, upward curl determination is set to 1 at step S47 and the procedure proceeds to step S49. On the other hand, in a case of “NO” at step S45, that is, in a case where the upward curl detection flag indicates 0, the procedure directly proceeds to step S49.

At step S49, a downward curl detection flag reset and an upward curl detection flag reset are set to 1. That is, the CPU 200 gives an instruction to reset the downward curl detection flag and the upward curl detection flag and the procedure returns to the entire processing of guide control illustrated in FIG. 16.

By returning to FIG. 16, processing of moving the delivering guides 110 is performed at next step S29. At step S29, as illustrated in FIG. 18, control of movement of the delivering guides 110 is performed on the basis of existence of curl and a direction thereof. Here, first, whether or not the downward curl determination indicates 1 is determined at step S51.

In a case of “YES” at step S51, that is, in a case where it is determined that the sheet is downwardly curled, the procedure proceeds to step S53. At step S53, a control signal to drive the motor 132y of the lower guide mechanism 112y is output to move the lower guide 110y to the downstream-side regulating position. At next step S55, whether or not count of the timer 304d reaches a predetermined value is determined. The predetermined value here is a time during which the front end of the sheet passes through the guide piece 116y of the lower guide 110y from the position of the third passage sensor 70c. In a case of “NO” at step S55, that is, in a case where the front end of the sheet has not passed through the guide piece 116y of the lower guide 110y yet, the CPU 200 waits as it is until the count of the timer 304d reaches the predetermined value. On the other hand, in a case of “YES” at step S55, the procedure proceeds to step S57. A step S57, a control signal to drive the motor 132x of the upper guide mechanism 112x is output to move the upper guide 110x to the upstream-side regulating position. That is, at a timing immediately after the front end of the sheet passes through the guide piece 116y of the lower guide 110y, the CPU 200 moves the upper guide 110x to the upstream-side regulating position. Thereby, movement of arrangement of the delivering guides 110 when the sheet is downwardly curled ends, so that the procedure returns to the entire processing of guide control illustrated in FIG. 16.

On the other hand, in a case of “NO” at step S51, that is, in a case where it is determined that the sheet is not downwardly curled, the procedure proceeds to step S59. At step S59, whether or not upward curl determination indicates 1 is determined. In a case of “YES” at step S59, that is, in a case where it is determined that the sheet is upwardly curled, the procedure proceeds to step S61. At step S61, a control signal to drive the motor 132x of the upper guide mechanism 112x is output to move the upper guide 110x to the downstream-side regulating position. At next step S63, whether or not the count of the timer 304d reaches the predetermined value is determined. In a case of “NO” at step S63, the CPU 200 waits as it is until the count of the timer 304d reaches the predetermined value. On the other hand, in a case of “YES” at step S63, the procedure proceeds to step S65, and a control signal to drive the motor 132y of the lower guide mechanism 112y is output to move the lower guide 110y to the upstream-side regulating position. That is, at a timing immediately after the front end of the sheet passes through the guide piece 116x of the upper guide 110x, the CPU 200 moves the lower guide 110y to the upstream-side regulating position. Thereby, movement of arrangement of the delivering guides 110 when the sheet is upwardly curled ends, so that the procedure returns to the entire processing of guide control illustrated in FIG. 16.

Alternatively, in a case of “NO” at step S59, that is, in a case where it is determined that the sheet is not downwardly curled or upwardly curled, the procedure returns to the entire processing of guide control illustrated in FIG. 16 without moving the delivering guides 110.

After returning to FIG. 16, when the processing of moving the delivering guides 110 at step S29 ends, whether or not the third passage sensor 70c is turned off is determined at step S31. In a case of “NO” at step S31, that is, in a case where the third passage sensor 70c remains in the on state, the CPU 200 waits as it is until the third passage sensor 70c is turned off. On the other hand, in a case of “YES” at step S31, that is, in a case where the third passage sensor 70c changes to be in the off state, it is determined that a rear end of the sheet passes through the detection position of the third passage sensor 70c, and the procedure proceeds to step S33.

At step S33, the delivering guides 110 are moved to the retracted position. That is, the CPU 200 outputs a control signal to drive the motor 132x of the upper guide mechanism 112x and the motor 132y of the lower guide mechanism 112y to return the upper guide 110x and the lower guide 110y to the retracted position that is the initial position.

At next step S35, whether or not there is a next job is determined. In a case of “YES” at step S35, that is, in a case where there is a next job, the procedure returns to step S21. On the other hand, in a case of “NO” at step S35, that is, in a case where there is no next job, the entire processing of guide control ends.

As described above, according to the first example, when a sheet is curled, the supplementary conveyance path L4 that is inclined in a direction opposite to a curl direction of the sheet is formed by the pair of delivering guides 110, so that an angle of a front end of the sheet when the sheet is delivered to the post-processing device 102 is able to be fit to the sheet conveyance direction. Thus, even when the sheet is curled, the sheet is able to be appropriately delivered from the image forming apparatus 10 to the post-processing device 102 and occurrence of a malfunction such as sheet jamming is able to be suppressed.

### Second Example

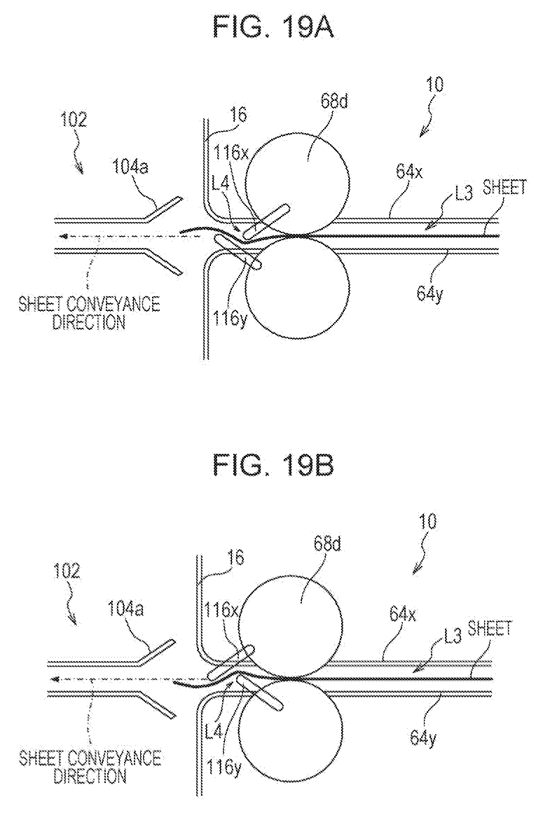

Next, an image forming apparatus 10 that is a second example of the disclosure will be described with reference to FIGS. 19A and 19B. The first example described above and the second example are different in shapes of the guide pieces 116 of the delivering guides 110. The other points are similar to those of the first example, so that a common part to that of the first example described above will be given the same reference sign and redundant description thereof will be omitted or simplified.

As illustrated in FIGS. 19A and 19B, in the second example, the guide pieces 116 of the delivering guides 110 are formed into a rod-like rib shape and are arranged so as to extend in the sheet conveyance direction and so as to be arrayed with a predetermined interval in the direction orthogonal to the sheet conveyance direction.

When a sheet is downwardly curled, as illustrated in FIG. 19A, the delivering guides 110 move so that the guide piece 116y of the lower guide 110y is positioned on the downstream side of the guide piece 116x of the upper guide 110x in the sheet conveyance direction and the tip ends of both the guide pieces 116 are positioned to be overlapped with each other in the vertical direction, and the supplementary conveyance path L4 that extends in the obliquely upward direction is formed on the downstream side of the fourth conveyance roller 68d in the sheet conveyance direction. On the other hand, when the sheet is upwardly curled, as illustrated in FIG. 19B, the delivering guides 110 move so that the guide piece 116x of the upper guide 110x is positioned on the downstream side of the guide piece 116y of the lower guide 110y in the sheet conveyance direction and the tip ends of both the guide pieces 116 are positioned to be overlapped with each other in the vertical direction, and the supplementary conveyance path L4 that extends in the obliquely downward direction is formed on the downstream side of the fourth conveyance roller 68d in the sheet conveyance direction. Note that, in such a case as well, it is desirable that after one of the delivering guides 110, which is arranged on the downstream side in the sheet conveyance direction, is moved, the other delivering guide 110 arranged on the upstream side in the sheet conveyance direction is moved.

The second example also exerts an action effect similar to that of the first example and the sheet is able to be appropriately delivered from the image forming apparatus 10 to the post-processing device 102 even when the sheet is curled, thus making it possible to suppress occurrence of a malfunction such as sheet jamming.

However, specific aspects of a shape of the delivering guides, the movement mechanism, and the like are not limited to the aforementioned aspects of the first example and the second example and may be appropriately modified as long as the supplementary conveyance path that is inclined in the direction opposite to the curl direction of the sheet is able to be formed on the downstream side of the sheet discharge roller in the sheet conveyance direction.

For example, the pair of delivering guides 110 is driven by using two individual motors 132 in the examples described above, but may be configured to be driven by one common motor.

When the supplementary conveyance path is formed by the pair of delivering guides, it is not necessary to move both the upper guide and the lower guide, and only one of the guides may be moved. That is, when the sheet is downwardly curled, only the lower guide may be moved to the downstream-side regulating position, and when the sheet is upwardly curled, only the upper guide may be moved to the downstream-side regulating position.

Though the delivering guides 110 are moved in the oblique direction relative to the sheet conveyance direction from the retracted position so as to be displaced to the upstream-side or downstream-side regulating position in the aforementioned examples, the delivering guides may be allowed to be displaced between the retracted position and the regulating position by being rotated around a fulcrum.

Further, the delivering guides 110 are configured so as to be able to correspond to both an upwardly curled sheet and a downwardly curled sheet in the aforementioned examples, but may be configured to be able to, when a direction in which curl is generated is decided as one direction by apparatus characteristics, correspond to only the direction. Moreover, in a case of an image forming apparatus in which a direction of curl is decided as one direction, it is not necessary to detect even the direction of curl as long as at least existence of curl is able to be detected. That is, the delivering guides may be moved to a predetermined regulating position in accordance with the existence of curl. Further, in the case of the image forming apparatus in which the direction of curl is decided as one direction, only one guide of the pair of delivering guides may be movable so as to change mutual relative positions, and the other guide may be configured not to be movable by a guide plate or the like.

Furthermore, though existence of curl and a direction thereof are detected in the aforementioned examples, a size of curl may be also detected so that an inclination angle of the supplementary conveyance path formed by the delivering guides is also able to be changed in accordance with the size of curl.

Moreover, though sheet curl information is directly detected by using the curl detection sensors 80 in the aforementioned examples, the curl information may be detected through estimation based on a printing condition. For example, the existence of curl is able to be detected on the basis of a humidity and a type of the sheet.

### Third Example

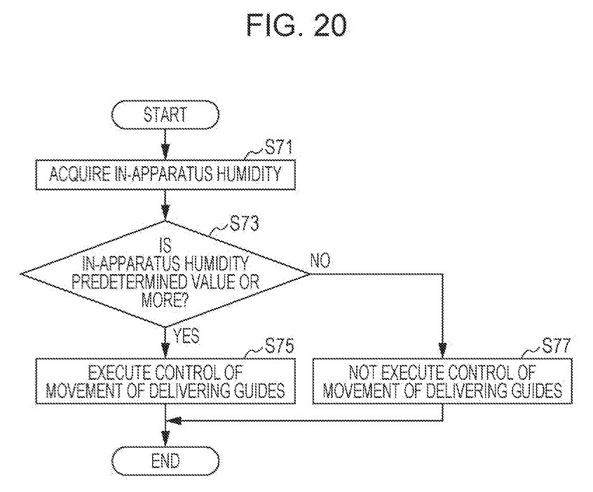

Next, an image forming apparatus that is a third example of the disclosure will be described with reference to FIG. 20. The image forming apparatus of the third example is an image forming apparatus that has apparatus characteristics that a direction in which curl is generated is only one direction and detects existence of curl on the basis of an in-apparatus humidity detected by a humidity sensor (not illustrated) provided in an apparatus main body. When there is curl, relative positions of a pair of delivering guides are changed to form a supplementary conveyance path that is inclined in a direction opposite to the curl direction of the sheet. Since the other points are the same as those of the first example, FIG. 20 illustrates an example of entire processing of guide control and redundant description thereof will be omitted or simplified.

As illustrated in FIG. 20, in the third example, when a job starts, a CPU of the image forming apparatus acquires in-apparatus humidity data from the humidity sensor at step S71. At next step S73, whether or not the in-apparatus humidity is a predetermined value (for example, 70%) or more is determined. That is, on the basis of the in-apparatus humidity, the CPU determines whether or not curl is generated in a sheet.

In a case of “YES” at step S73, that is, in a case where the in-apparatus humidity is the predetermined value or more, it is determined that curl is generated in the sheet, and the procedure proceeds to step S75. At step S75, control of movement of delivering guides is executed at step S75. That is, a pair of delivering guides are moved to a predetermined regulating position at a timing set in advance and the supplementary conveyance path is formed. On the other hand, in a case of “NO” at step S73, that is, in a case where the in-apparatus humidity is less than the predetermined value, it is determined that no curl is generated in the sheet, and the procedure proceeds to step S77. At step S77, control of movement of the delivering guides is not executed. That is, the sheet is fed to a post-processing device while the delivering guides are kept at a retracted position and not moved.

The third example also exerts an action effect similar to that of the first example and the sheet is able to be appropriately delivered from the image forming apparatus to the post-processing device even when the sheet is curled, thus making it possible to suppress occurrence of a malfunction such as sheet jamming.

Note that, though the delivering unit 62 is provided in the relay conveyance device 16 in the aforementioned examples, the image forming apparatus may not include the relay conveyance device and the delivering unit including the sheet discharge roller, the delivering guides, and the like may be provided in the apparatus main body. Moreover, the attached device attached to the image forming apparatus may be the relay conveyance device. That is, the delivering unit including the sheet discharge roller and the pair of delivering guides may deliver a sheet to the relay conveyance device.

Further, specific numerical values, component shapes, and the like which have been mentioned above are mere examples and may be changed as appropriate in accordance with requirements of a product specification or the like.

The present disclosure contains subject matter related to that disclosed in Japanese Priority Patent Application JP 2018-082721 filed in the Japan Patent Office on Apr. 24, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus including a delivering unit that delivers a sheet, on which an image has been formed, to an attached device, the image forming apparatus comprising:
a curl detection unit that detects curl information of the sheet, which includes existence of curl;
a sheet discharge roller that is provided in the delivering unit;
a pair of delivering guides that is provided in the delivering unit so as to be changeable mutual relative positions; and
a guide control unit that, when generation of curl in the sheet is detected by the curl detection unit, changes the relative positions of the pair of delivering guides so that a supplementary conveyance path inclined in a direction opposite to a curl direction of the sheet is formed on a downstream side of the sheet discharge roller in a sheet conveyance direction.

2. The image forming apparatus according to claim 1, wherein, when forming the supplementary conveyance path by the pair of delivering guides, the guide control unit moves, among the pair of delivering guides, one guide arranged on the downstream side in the sheet conveyance direction and then moves the other guide arranged on an upstream side in the sheet conveyance direction.

3. The image forming apparatus according to claim 1, wherein
the attached device is a post-processing device,
the image forming apparatus includes an apparatus main body and a relay conveyance device that relays and conveys the sheet, which is discharged from the apparatus main body, to the post-processing device, and
the delivering unit including the sheet discharge roller and the pair of delivering guides is provided in the relay conveyance device.

4. A non-transitory recording medium in which a control program of an image forming apparatus that includes a delivering unit that delivers a sheet, on which an image has been formed, to an attached device, a sheet discharge roller that is provided in the delivering unit, and a pair of delivering guides that is provided in the delivering unit so as to be changeable mutual relative positions is stored, wherein
a program is stored that causes a processor of the image forming apparatus to execute
performing curl detection processing of detecting curl information of the sheet, which includes existence of curl, and
performing guide control processing of changing, when generation of curl in the sheet is detected by the curl detection processing, the relative positions of the pair of delivering guides so that a supplementary conveyance path inclined in a direction opposite to a curl direction of the sheet is formed on a downstream side of the sheet discharge roller in a sheet conveyance direction.

5. A control method of an image forming apparatus that includes a delivering unit that delivers a sheet, on which an image has been formed, to an attached device, a sheet discharge roller that is provided in the delivering unit, and a pair of delivering guides that is provided in the delivering unit so as to be changeable mutual relative positions, the method comprising:
detecting curl information of the sheet, which includes existence of curl; and
changing, when generation of curl in the sheet is detected, the relative positions of the pair of delivering guides so that a supplementary conveyance path inclined in a direction opposite to a curl direction of the sheet is formed on a downstream side of the sheet discharge roller in a sheet conveyance direction.
